(19) United States
(12) Patent Application Publication
(10) Pub. No.: US 2026/0204096 A1
(43) Pub. Date: Jul. 16, 2026

(54) FACIAL AUTOMATED RECOGNITION SYSTEM FOR TIME MANAGEMENT AND CUSTOMER ENGAGEMENT

(71) Applicant: Ornis Mala, Frisco, TX (US)

(72) Inventor: Ornis Mala, Frisco, TX (US)

(73) Assignee: Kore.co Inc., Frisco, TX (US)

(21) Appl. No.: 19/434,352

(22) Filed: Dec. 29, 2025

Related U.S. Application Data
(60) Provisional application No. 63/745,845, filed on Jan. 16, 2025.

(51) Int. Cl. G06V 40/16; G06Q 30/01; G06Q 30/0226; G07C 1/00

(52) U.S. Cl. CPC G06V 40/172; G06Q 30/01; G06Q 30/0226; G07C 1/00

(57) ABSTRACT

A facial recognition-based system and method for automating time management and customer engagement. The system identifies employees and customers upon entry and exit, integrates with loyalty programs, and provides real-time notifications for unknown visitors. It includes facial recognition devices, a processor, a loyalty program module, and an analytics module for operational insights.

### CROSS-REFERENCE TO RELATED APPLICATION

This application claims priority to U.S. Provisional Application Ser. No. 63/745,845, filed Jan. 16, 2025, entitled FACIAL AUTOMATED RECOGNITION SYSTEM FOR TIME MANAGEMENT AND CUSTOMER ENGAGEMENT, which is hereby incorporated by reference in its entirety.

### BACKGROUND OF THE INVENTION

### I. Field of the Invention

The present disclosure relates generally to automated facial recognition technology, and more specifically to systems and methods for automating time management and customer engagement through integrated facial recognition devices and loyalty program mechanisms.

### II. Description of the Prior Art

The current art includes numerous types of systems and methods used for employee attendance tracking and security purposes. Indeed, facial recognition technology is now fairly widely used in corporate environments for attendance tracking, ensuring accurate records of employee arrival and departure times, monitoring overtime, generating reminders, and supporting workforce management. Facial recognition time clocks have been increasingly replacing badges, fingerprints and PINs. They can automate clock in/out, prevent time theft (so-called “buddy punching”), track breaks, and integrate with payroll. Many also support geofencing, offline mode, and anti-spoofing (detection of masks/photos).

The current art also includes numerous types of systems and methods used for customer engagement and loyalty program purposes. Businesses increasingly rely on these types of loyalty programs to retain customers and enhance personalized experiences. However, most loyalty systems still require customer-initiated interaction such as scanning cards, entering phone numbers, or using mobile applications. Such steps reduce program adoption and limit real-time personalized engagement opportunities. Facial recognition technology would certainly enhance these legacy systems. Indeed, an opt-in system capable of identifying returning customers upon entry, alerting staff to VIPs, pulling up purchase history from CRM/loyalty databases, and enabling personalized greetings, recommendations, or offers would be greatly beneficial. They can incorporate with digital signage for targeted ads, frictionless redemption of points, and even so-called “face pay” or automated loyalty accrual.

Existing systems are typically limited to employee time logging and lack integrated customer engagement or loyalty program functionality. Indeed, employee attendance and customer loyalty often run on separate platforms/vendors, requiring duplicate hardware, databases, and enrollments. Businesses require a solution that combines operational efficiency with enhanced customer interaction.

As such, there is a need for systems and methods that combine automated facial recognition with customer engagement workflows, allowing businesses to seamlessly identify visitors, determine whether they are known or unknown customers, automate loyalty tracking, and notify managers of engagement opportunities.

Accordingly, it is a general object of the present disclosure to provide an automated system that combines time management and customer engagement.

It is another general object of this disclosure to provide cost savings from consolidated infrastructure.

It is another general object of this disclosure to provide one secure, consented biometric template per person, tagged as employee, customer or both.

It is a more specific object of the present disclosure to provide role-based access wherein employees are only processed for attendance/access and customers only for loyalty whereby data expires for non-enrolled visitors.

It is another more specific object of the present disclosure to provide a frictionless engagement for employee auto-clock via walk-up and customers get instant personalization without applications/cards/phones.

These and other objects, features and advantages of this disclosure will be clearly understood through a consideration of the following detailed description.

### SUMMARY OF THE INVENTION

According to an embodiment of the present disclosure, there is provided a According to an embodiment of the present disclosure, there is provided a facial recognition system for time management and customer engagement in a business establishment. The system includes one or more facial recognition capture devices positioned at entrances, exits, or points of interaction within the business establishment that are configured to capture facial images of individuals. A processor is communicatively coupled to the facial recognition capture devices and is configured to perform initial face detection and quality screening on the captured facial images. A system server is in communication with the processor and is configured to perform facial recognition and matching of biometric templates generated from the captured facial images against enrolled biometric templates. A database is communicatively coupled to the system server and stores the enrolled biometric templates, wherein each enrolled biometric template is associated with a unique person record and one or more role tags selected from the group consisting of employee, customer, and both. An application platform is integrated with the system server and is configured to classify recognized individuals based on the one or more role tags, retrieve corresponding profiles from the database, and initiate role-specific workflows, wherein the role-specific workflows include attendance management for individuals tagged as employees and customer engagement for individuals tagged as customers.

There is also provided a method for facial recognition-based time management and customer engagement in a business establishment consisting of capturing, using one or more facial recognition capture devices positioned at entrances, exits, or points of interaction, a facial image of a person entering or existing the business establishment; performing, at a local edge processor, initial face detection and quality screening on the captured facial image to generate approved frames; forwarding the approved frames to a system server for facial recognition; generating or matching, at the system server, a biometric template from the approved frames against enrolled biometric templates stored in a database, each enrolled biometric template associated with a unique person record and one or more role tags selected from the group consisting of employee, customer, and both; classifying the person as an employee, a customer, or a non-enrolled visitor based on the matching and the one or more role tags; and executing, via an application platform integrated with the system server, role-specific workflows based on the classification, wherein the role-specific workflows include updating attendance records for employees and providing customer engagement for customers.

### BRIEF DESCRIPTION OF THE DRAWINGS

The present disclosure will be more fully understood by reference to the following detailed description of one or more preferred embodiments when read in conjunction with the accompanying drawings, in which like reference characters refer to like parts throughout the views and in which:

FIG. 1 is a simplified system diagram of the facial automated recognition system for time management and customer engagement according to the principles of an embodiment of the present disclosure.

FIG. 2 is a general logic flow diagram illustrating the integration of the system of FIG. 1 with employee time tracking workflows.

FIG. 3 is a general logic flow diagram illustrating the integration of the system of FIG. 1 with customer registration and loyalty reward redemption workflows.

### DESCRIPTION OF THE PREFERRED EMBODIMENTS

A system for facial recognition is configured to identify individuals upon entry and exit of a business establishment, automatically log customer or employee activity, facilitate loyalty program participation, and notify managers of unknown customers for real-time engagement.

In one embodiment, a system includes one or more facial recognition capture devices positioned at entrances, exits, or points of interaction; a local edge processor; a system server; and an application platform that integrates attendance management with customer engagement. The system classifies recognized individuals as employees, customers, or visitors; retrieves corresponding profiles from databases; and initiates role-specific workflows for clock-in/out, access control, loyalty accrual/redemption, and personalized messaging.

In another embodiment, a method includes capturing a facial image of a person entering a venue; generating or matching a biometric template against enrolled records; determining whether the person is an employee, customer, or non-enrolled visitor; and, based on the determination, executing workflows including employee time updates, customer greeting and loyalty rewards, or temporary visitor handling and staff alerts.

An analytics module provides operational insights, including conversion rates from guest to enrolled customer, employee attendance patterns, and system health metrics. These analytics tools log customer behavior, generate performance reports, track visit frequency and duration, and evaluate the effectiveness of loyalty program participation and engagement strategies. Administrators configure policies for retention, consent workflows, notification thresholds (e.g., VIP arrival alerts), and integrations. Role-based dashboards separate HR operations from marketing/loyalty operations. Edge processing reduces latency and bandwidth by performing detection and quality filtering near the cameras. Server-side processing handles recognition, matching, and orchestration. The system exposes APIs for integration with third-party payroll, POS, CRM, and signage systems. Deployment can be hybrid, with local servers and cloud services as permitted by privacy policies and regulations.

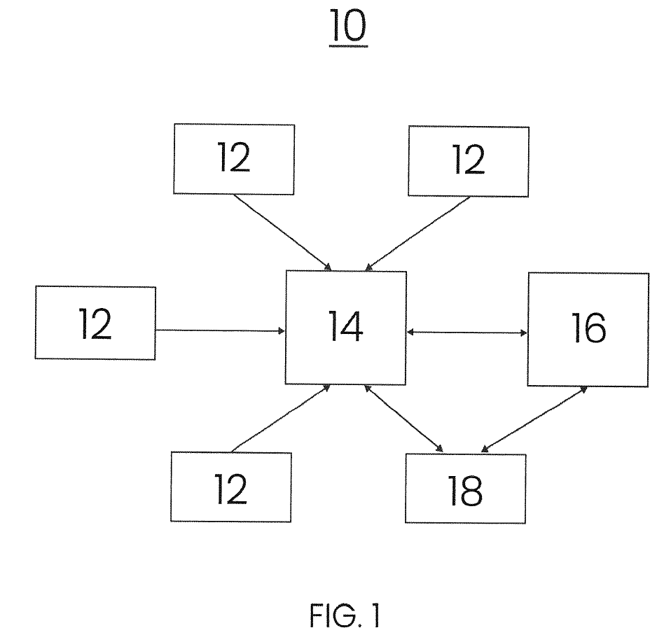

Turning now to the Figures, and in particular the simplified diagram of FIG. 1, the facial automated recognition system 10 includes cameras 12, a local server and processing unit 14 and a system server architecture 16 for time management and customer engagement. The system includes multiple cameras 12 situated at entryways, interior zones, and point-of-sale areas. These cameras 12 may be wall mounted, desk stand, or floor stand devices. Further, these cameras 12 may include dedicated kiosks or tablets at entry points. The system may further still utilize geofencing and require GPS location match (via a mobile app) to prevent remote clock-ins. Each camera 12 streams to a local processor 14 that performs initial face detection and quality screening. Approved frames are forwarded to a server system 16 that performs face recognition, matching, and workflow orchestration. A processor database 18 stores biometric templates created with explicit consent. Each template is associated with a unique person record and role tags: employee, customer, or both. Role tags determine which workflows and data retention policies apply. Integration modules connect to payroll systems for attendance and to customer relationship management (CRM)/loyalty platforms for customer engagement. Security controls include anti-spoofing (liveness detection), encryption at rest and in transit, role-based access control (RBAC), and audit logging. A privacy manager enforces opt-in enrollment, configurable retention, and deletion for non-enrolled visitors, e.g., discarding ephemeral templates after a grace period or immediately.

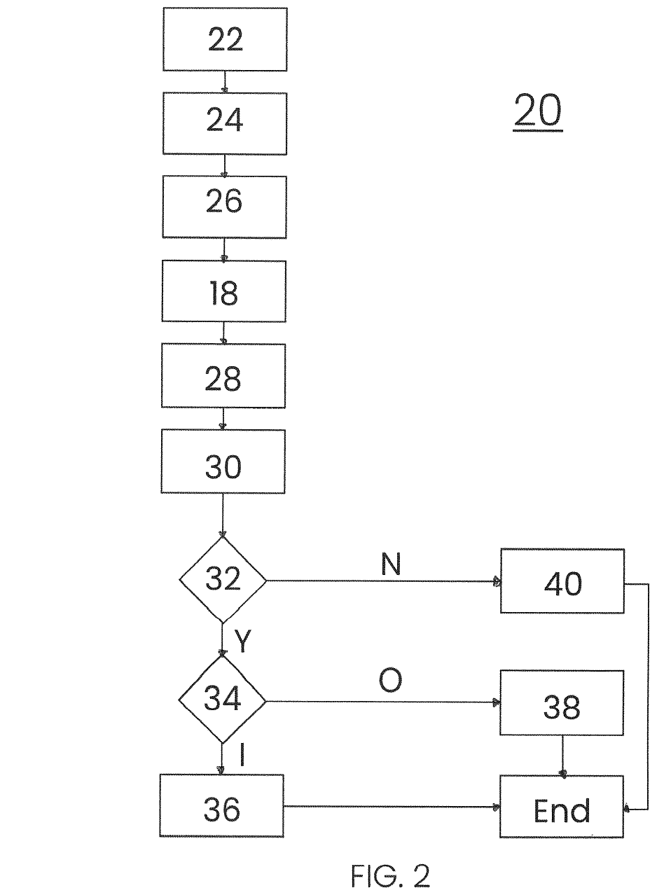

FIG. 2 is a logic flow diagram for employee enrollment and daily attendance 20, including a start 22. During enrollment 24, an employee presents themselves to a camera 12 for face capture 26. The system performs detection, quality assessment (pose, illumination, occlusion), and template creation. The template is stored in a secure database 18 linked to the employee ID (the so-called biometric identification). For daily attendance 28, the system detects a face 30 upon entry, retrieves the corresponding employee record if enrolled 32, and automatically clocked the employee in 34 and updates attendance 36. When the employee exits, the system records clock-out time 38. If a face is detected that is not enrolled as an employee, access is denied 40 (or flagged) according to predefined policies. Attendance updates 36 include break tracking, overtime calculation, anomaly detection (missed punches, early leaves), and integration with payroll. Compliance features support geofencing, offline buffering when connectivity is unavailable, and anti-spoofing to prevent proxy “buddy punching”.

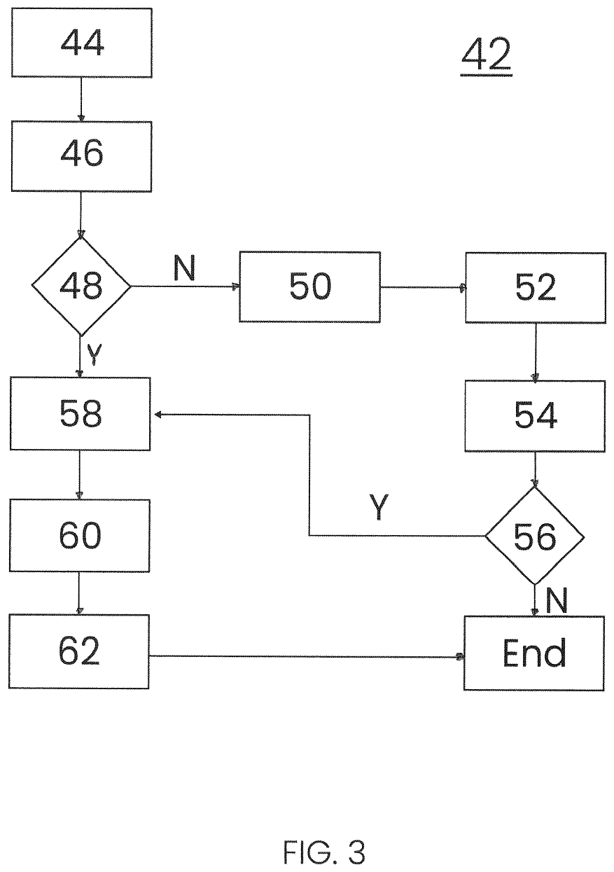

FIG. 3 is a logic flow diagram for customer workflows 42, including a start 44. Upon detecting a face 46, the system determines 48 whether the person is an enrolled customer. If not enrolled, and the unknown customer does not self-register, a temporary guest profile 50 may be created, and staff are alerted 52 (e.g., email, text) for optional greeting 54 (personal approach), and consent-based enrollment 56. Enrollment 56 may include tablets or other PCDs to enhance interaction. For enrolled customers, the system retrieves the profiles 58, including loyalty tier, points balance, and purchase history. Digital signage or staff devices (e.g., tablets, PCDs) present personalized greetings, loyalty program details, and offers. Points are accrued 60 automatically on visit or purchase, and redemption 62 can occur frictionlessly at checkout. The system allows customers to earn/redeem loyalty points automatically, upon entry or purchase without showing a card, scanning a QR code, or opening an app. The customer simply walks in (or approaches a payment kiosk), the system recognizes their face, links it to their loyalty account, and instantly applies rewards, offers, or accumulates points. Rewards mechanisms may include QR codes, tokens, or gifts provided upon registration and/or milestone achievements. The system supports session management, such as linking encounters across zones (entrance, browsing area, POS), and enables targeted engagement. When the customer opts to enroll, the system creates a biometric template and associates it with the loyalty account under explicit consent. This system leverages facial recognition technology to revolutionize customer loyalty programs. By automatically recognition and engagement processes, the system enhances operational efficiency and customer satisfaction.

The foregoing detailed description has been given for clearness of understanding only and no unnecessary limitations should be understood therefrom. Accordingly, while one or more particular embodiments of the disclosure have been shown and described, it will be apparent to those skilled in the art that changes and modifications may be made therein without departing from the invention if its broader aspects, and, therefore, the aim in the appended claims is to cover all such changes and modifications as fall within the true spirit and scope of the present disclosure.

What is claimed is:

1. A facial recognition system for time management and customer engagement in a business establishment, comprising:
one or more facial recognition capture devices positioned at entrances, exits, or points of interaction within the business establishment, the one or more facial recognition capture devices configured to capture facial images of individuals;
a processor communicatively coupled to the one or more facial recognition capture devices, the processor configured to perform initial face detection and quality screening on the captured facial images;
a system server in communication with the processor, the system server configured to perform facial recognition and matching of biometric templates generated from the captured facial images against enrolled biometric templates;
a database communicatively coupled to the system server, the database storing the enrolled biometric templates, each enrolled biometric template associated with a unique person record and one or more role tags selected from the group consisting of employee, customer, and both; and
an application platform integrated with the system server, the application platform configured to classify recognized individuals based on the one or more role tags, retrieve corresponding profiles from the database, and initiate role-specific workflows, wherein the role-specific workflows include attendance management for individuals tagged as employees and customer engagement for individuals tagged as customers.

2. The system of claim 1, wherein the attendance management includes automatic clock-in upon entry detection and automatic clock-out upon exit detection.

3. The system of claim 1, wherein the customer engagement includes retrieving loyalty program data.

4. The system of claim 1, further comprising an analytics module configured to provide operational insights.

5. The system of claim 1, wherein the system server is further configured to handle non-enrolled visitors by alerting staff for engagement opportunities.

6. The system of claim 1, further comprising security controls.

7. The system of claim 1, wherein the one or more facial recognition capture devices include cameras selected from the group consisting of wall-mounted cameras, desk stand cameras, floor stand cameras, dedicated kiosks, and tablets.

8. The system of claim 1, further comprising integration modules configured to connect the system server to third-party systems selected from the group consisting of payroll systems, point-of-sale systems, customer relationship management systems, and digital signage systems.

9. The system of claim 1, wherein the system supports geofencing to require a location match for employee clock-ins.

10. The system of claim 1, wherein the application platform includes role-based dashboards separating human resources operations for attendance from marketing operations for loyalty programs.

11. A method for facial recognition-based time management and customer engagement in a business establishment, comprising:
capturing, using one or more facial recognition capture devices positioned at entrances, exits, or points of interaction, a facial image of a person entering or exiting the business establishment;
performing, at a local edge processor, initial face detection and quality screening on the captured facial image to generate approved frames;
forwarding the approved frames to a system server for facial recognition;
generating or matching, at the system server, a biometric template from the approved frames against enrolled biometric templates stored in a database, each enrolled biometric template associated with a unique person record and one or more role tags selected from the group consisting of employee, customer, and both;
classifying the person as an employee, a customer, or a non-enrolled visitor based on the matching and the one or more role tags; and
executing, via an application platform integrated with the system server, role-specific workflows based on the classification, wherein the role-specific workflows include updating attendance records for employees and providing customer engagement for customers.

12. The method of claim 11, wherein updating attendance records for employees comprises automatically logging clock-in time upon entry and logging clock-out time upon exit.

13. The method of claim 11, wherein providing customer engagement for customers comprises accruing loyalty points automatically.

14. The method of claim 11, further comprising, for non-enrolled visitors: alerting staff via notification for real-time engagement.

15. The method of claim 11, further comprising generating analytics insights including loyalty program participation effectiveness.

16. The method of claim 11, wherein the quality screening includes anti-spoofing to detect liveness.

17. The method of claim 11, further comprising enrolling a new individual by capturing a facial image, creating a biometric template with explicit consent, associating the biometric template with a role tag, and storing the biometric template in the database.

18. The method of claim 11, wherein executing the role-specific workflows includes session management to link encounters across multiple zones within the business establishment and targeted engagement based on retrieved profiles.

19. The method of claim 11, further comprising enforcing security measures.

20. The method of claim 11, wherein the method supports geofencing to validate location for employee attendance.
